(19) United States
(12) Patent Application Publication
(10) Pub. No.: US 2019/0277081 A1
(43) Pub. Date: Sep. 12, 2019

(54) MODULAR SYSTEM FOR A MULTIPLE INSULATING GLAZING UNIT, MULTIPLE INSULATING GLAZING UNIT, AND METHOD FOR PRODUCING THE MULTIPLE INSULATING GLAZING UNIT

(71) Applicant: SAINT-GOBAIN GLASS FRANCE, Courbevoie (FR)

(72) Inventors: Walter SCHREIBER, Aachen (DE); Hans-Werner KUSTER, Aachen (DE); Marc MAURER, Saint Jean aux Bois (FR)

(21) Appl. No.: 16/332,990

(22) PCT Filed: Jul. 3, 2017
(86) PCT No.: PCT/EP2017/066460

§ 371 Date: Mar. 13, 2019

(30) Foreign Application Priority Data
Sep. 15, 2016 (EP) 16188982.9

(51) Int. Cl. E06B 3/663; E06B 3/67

(52) U.S. Cl. CPC E06B 3/66366; E06B 2009/2643; E06B 3/66342; E06B 3/6722

(57) ABSTRACT

A modular system for a multiple insulating glazing unit includes a double glazing component having a first and second pane elements with first and second pane sealing surfaces, a spacer arranged between the first and second pane sealing surfaces and composed of a spacer strut that encloses an insulating glass volume between the first and second pane elements and is fixed in a gas-tight manner by a fixing system to the first and second pane sealing surfaces. The spacer strut is arranged as a frame open in sections such that a receiving opening is implemented between two spacer struts, which receiving opening is dimensioned such that a third pane element is insertable through the opening into the insulating glass volume. The modular system also includes a closure component with the third pane element, and a closure sealing system for the gas-tight closure of the insulating glass volume.

The invention relates to a modular system for a multiple insulating glazing unit, a multiple insulating glazing unit, and a method for producing the multiple insulating glazing unit. The modular system is suitable to provide a multiple insulating glazing unit comprising two or more components.

The thermal conductivity of glass is lower by roughly a factor of 2 to 3 than that of concrete or similar building materials. However, since, in most cases, glass panes are designed significantly thinner than comparable elements made of brick or concrete, buildings frequently lose the greatest share of heat via external glazing. This effect is particularly significant in highrises with very extensive or complete glass façades relative to the façade surface. The increased costs necessary for heating and air-conditioning systems make up a part of the maintenance costs of the building that must not be underestimated. Moreover, as a consequence of more stringent construction regulations, lower carbon dioxide emissions are required. Consequently, in the window and façade area of buildings, insulating glazing units are almost exclusively used nowadays.

Double insulating glazing units usually consists of two pane elements that are arranged by means of a spacer at a defined distance from one another. The thermal insulation capacity of triple insulating glazing units is further increased in comparison with single or double glazing units. In order to produce a triple insulating glazing unit, an additional pane can, for example, be placed on a double glazing unit by means of an additional attachment means. Such a triple glazing unit is described in EP0922828A2. The glazing unit has a double glazing component with a first pane element with a first pane sealing surface, a second pane element with a second pane sealing surface, a spacer arranged between the first pane sealing surface and the second pane sealing surface and composed of at least two spacer struts that enclose an insulating glass volume between the first pane element and the second pane element and are fixed in a gas-tight manner by fixing means to the first pane sealing surface and to the second pane sealing surface. This double glazing unit is inserted in a casement frame on which a third pane element is detachably arranged.

The production of such a triple glazing unit is, in comparison to the industrial production of double glazing units, substantially more complicated since either additional plant components for the installation of another pane must be provided or a time-consuming multiple pass through a conventional system is necessary.

Furthermore, CA 2 876 598 A1 describes a multiple glazing unit that has a double glazing, whose panes are held at a distance by a spacer that has a recess into which a stained glass is inserted in order to provide a decorative window.

Further known, from US 2001/001357 A1, are triple insulating glazing units that have a first pane element and a second pane element, between which a one-piece spacer is arranged, which receives a third pane element between the first pane element and the second pane element in an insert. For producing such a multiple insulating glazing unit, the one-piece spacer is first arranged around the outer edges of the third pane element. For this, the spacer is folded at bending points that come to rest at the corners of the third pane element. Finally, a connection means serves to close the frame formed by the spacer. In subsequent steps, the first pane element and the second pane element are glued parallel to the third pane element to opposing outer edges of the spacer, in order to obtain a multiple insulating glazing unit in the form of a triple glazing unit.

The object of the present invention is to provide a modular system for a multiple insulating glazing unit that enables significantly simplified production of a multiple insulating glazing unit and is economical. A further object is to provide the multiple insulating glazing unit and a method for production thereof that are economical.

The object of the present invention is accomplished according to the invention by a modular system, a multiple insulating glazing unit, and a method for producing the multiple insulating glazing unit according to claims 1, 14, and 15. Preferred embodiments of the invention are apparent from the dependent claims.

The invention relates to a modular system for a multiple insulating glazing unit comprising
a double glazing component having
   a first pane element with a first pane sealing surface,
   a second pane element with a second pane sealing surface,
   a spacer that is arranged between the first pane sealing surface and the second pane sealing surface and that is composed of at least one spacer strut that encloses an insulating glass volume between the first pane element and the second pane element and is fixed in a gas-tight manner by fixing means to the first pane sealing surface and to the second pane sealing surface, wherein the at least one spacer strut is implemented and arranged as a frame open in sections such that a receiving opening is implemented between two spacer struts, which receiving opening is dimensioned such that a third pane element can be inserted through said opening into the insulating glass volume of the double glazing component,
a closure component with the third pane element,
   and
a closure sealing means for the gas-tight closure of the insulating glass volume by the closure component after arranging the closure component on the receiving opening.

This modular system enables simple assembly of a multiple insulating glazing unit, in particular a triple insulating glazing unit, by being able to insert the third pane element into the double glazing component by sliding. Another advantage here is that the multiple insulating glazing unit can be varied in a simple manner as the third pane element can be selected from a variety of possible pane elements according to desired requirements of the user or purchaser of the modular system. The structure of the modular system is, in particular, advantageous when the third pane element is a delicate component of the insulating glazing unit that first has to be preassembled and tested for its functionality before it is introduced into its ultimate assembly position in the insulating glass volume. This is true in particular for third pane elements in the form of so-called “functional”, often electrically controlled glass panes or electrical display elements in pane form. Such third pane elements are sometimes highly delicate and very expensive. They have to be electrically contacted in the interior of the insulating glass volume and be fully functional for the long term. In a conventional production operation for a triple glazing unit, the multiple insulating glazing unit would first be assembled from three pane elements and two spacer systems and hermetically connected to one another. This operation is associated with a large number of processing steps. If, after the production of the hermetically sealed insulating glazing unit, it is determined that the delicate third pane element processed as an inner pane is not functional or not fully functional, the entire insulating glazing unit must be rejected.

In contrast, the inventive modular system enables a separate, preparatory preassembly of the third pane element without subjecting it to the processing steps for production of the double glazing component. The preassembled third pane element can be fully tested for its functionality before insertion into the insulating glass volume of the double glazing component. Only after that are the third pane element and the double glazing component “wed” to form a multiple insulating glazing unit. Thus, the rate of rejects during production of multiple insulating glazing units, in particular in the form of triple glazing units with a functional inner pane, is significantly reduced.

If the insertion of the third pane element is reversible, the modular system enables a simple exchange of the third pane element if this is indicated in the context of maintenance or remodeling.

The expression that spacer struts are implemented as “a frame open in sections” refers to a frame structure in which, along one frame section, for example, along one of its edges, a receiving opening is arranged in this frame section. This feature is also realized when the receiving opening results from the section-wise complete absence of a spacer strut. Then, as well, a receiving opening is implemented between two spacer struts. In the context of the invention, a spacer strut is a straight strut-like element that holds the first and the second pane element apart.

Selected as materials for the first pane element and the second pane element, which are preferably transparent and/or translucent, are, for example, materials from the group consisting of colored and uncolored glasses, colored and uncolored, rigid, clear plastics that are provided with a barrier layer against vapor diffusion. Preferably, however, colored and uncolored glasses are selected. Preferably, the colored and uncolored glass is selected from the group consisting of colored and uncolored, non-tempered, partially tempered, and tempered float glass, cast glass, ceramic glass, and glass. Particularly preferred is float glass.

The first and second pane sealing surface are areas of the first and second pane element that are joined via the fixing means, with the formation of a sealing boundary layer with the spacer.

The spacer is composed of spacer struts that enclose an insulating glass volume between the first pane element and the second pane element. The feature of enclosing includes the geometry that the frame formed from the spacer struts is not completely closed but, instead, is interrupted in sections by the complete absence of a spacer strut.

The fixing means fix the spacer struts in a gas-tight manner to the first pane sealing surface and to the second pane sealing surface. The fixing means are preferably sealing means, for example, butyl (polyisobutylene/PIB) that air-tightly close a gap between the spacer struts and the pane sealing surfaces.

The first and second pane element are preferably rectangular such that they have, in each case, four pane edges. The spacer is adapted to the shape of the pane element along its pane edges. The open frame formed from the at least one spacer strut is, in the case of rectangular geometry of the pane element, implemented along the pane edges, preferably substantially U-shaped along three pane edges or rectangular along all four pane edges. If only a single spacer strut is provided, it usually follows, in one piece, the course of the edges of the first and second pane element. In the case of a U-shaped or rectangular development of the extension of the spacer, the spacer can have a one-piece spacer strut that is shaped corresponding to this course. Alternatively, the spacer preferably has a plurality, in particular, along the pane edges of rectangular pane elements, three or four spacer struts which are joined to one another, for example, glued or welded or connected by corner connectors. Preferably, ends of the spacer struts that form the corners of the spacer are either welded or linked to one another via corner connectors.

Preferably, the spacer has a single receiving opening for the third pane element. It is, however, also possible to provide a plurality of receiving openings. The third pane element need not be adapted, in terms of its dimensioning, to the outer panes provided as the first and second pane element in order to form, as a whole, a triple glazing unit. It is likewise conceivable for the third pane element to occupy only a portion of the area of the outer pane that is smaller than two thirds or one half the area of the outer panes and, for example, only one fourth of the outer pane area. In particular, when the third pane element is implemented as an electrical display that is not intended to occupy the transparency of the entire double glazing component.

Preferably, at least one of the spacer struts is implemented as a holder strut and has the receiving opening. In this case, the open frame formed by the spacer is preferably rectangular and preferably has four spacer struts, one of which is implemented as a holder strut. However, it is also possible for a plurality of spacer struts to be provided with a plurality of receiving openings. The receiving opening is implemented in the holder strut such that it runs between two spacer struts adjacent the holder strut, with the two adjacent spacer struts extending perpendicular or substantially perpendicular to the holder strut. In the case of a one-piece configuration of the spacer strut, it is implemented along a section with a receiving opening and thus, in sections, in the form of a holder strut.

Preferably, the holder strut surrounds the receiving opening on all sides. In other words, the receiving opening is implemented as an elongated slot in the holder strut. However, it is still arranged between two spacer struts, since the holder strut is arranged between two spacer struts adjacent them. Here, the length of the receiving opening implemented as a slot occupies almost the entire holder strut. This is, in particular, the case when the modular system is intended to be used to realize a multiple insulating glazing unit, preferably a triple insulating glazing unit.

In all above-described variants of the modular system, adjacently connecting to the holder strut or to the receiving opening, a first sealing section on the first pane element and a second sealing section on the second pane element are preferably exposed. The sealing sections can be suitably implemented in particular for the arrangement of the closure component and the closure sealing means between the respective sealing section and the closure component. The closure sealing means is preferably implemented to be arranged circumferentially around the receiving opening such that after the joining of the components of the modular system, the closure sealing means is arranged between the closure component, the holder strut and/or the spacer struts, the first sealing section, and the second sealing section. Structurally, for this, the closure sealing means can be fixed on the closure component and/or on the first and second sealing section and on transverse sealing sections connecting these two sealing sections. The first and second sealing section and the transverse sealing sections together surround the receiving opening, in order to obtain a gas-tight connection of the closure components to the double glazing components.

Preferably, the first sealing section is arranged on the first pane sealing surface and the second sealing section is arranged on the second pane sealing surface. The holder strut of the spacer arranged between the first pane sealing surface and the second pane sealing surface does not end flush with the pane edges of the outer pane in this embodiment. Instead, the spacer is arranged such that the pane elements have surfaces positioned outside the insulating glass volume that form the sealing sections on the pane sealing surfaces.

In a preferred embodiment, the spacer struts are implemented moisture-tight against moisture penetrating from the outside but desiccant-free. They contain no desiccant acting on the insulating glass volume. In this embodiment, the spacer struts consequently serve for producing insulating glass volumes in the double glazing element, for deterring weather influences such as moisture and have sufficient thermal insulation between the first pane element and the second pane element for the multiple insulating glazing unit. Because of the fact that no desiccant is provided in the structure of the spacer, the spacer can be particularly slender. The functionality of the desiccant is introduced into the insulating glass volume of the double glazing component together with the third pane element. A description follows as to how the pane edges of the third pane element are surrounded by a further spacer which is inserted into the insulating glass volume.

In an alternatively preferred embodiment, the spacer struts are moisture-tight against moisture penetrating from the outside and contain, at least partially, a desiccant acting on the insulating glass volume. In this embodiment, the spacer struts form a spacer that preferably comprises a hollow main body having at least two parallel contact legs, one outer leg, two glazing interior legs, and a groove such that a first hollow space and a second hollow space that are separated by the groove are formed. A desiccant is at least partially arranged in the hollow spaces. The hollow main body extends between the first pane element and the second pane element. Whereas one pane contact leg is fixed to the first pane sealing surface of the first pane element, the other pane contact leg is fixed to the second pane sealing surface of the second pane element. Together with the first pane element and the second pane element, the glazing interior legs delimit the insulating glass volume. The groove serves to accommodate the third pane element.

All known prior art hollow body profiles, regardless of their material composition, can be used as the hollow main body.

Mentioned here by way of example for spacer struts are polymeric or metallic materials, regardless of whether or not they are implemented as hollow main bodies or as sheet or pane bodies.

Polymeric materials for spacer struts preferably include polyethylene (PE), polycarbonates (PC), polypropylene (PP), polystyrene, polybutadiene, polynitriles, polyesters, polyurethanes, polymethyl methacrylate, polyacrylates, polyamides, polyethylene terephthalate (PET), polybutylene terephthalate (PBT), particularly preferably acrylonitrile butadiene styrene (ABS), acrylonitrile styrene acrylester (ASA), acrylonitrile butadiene styrene/polycarbonate (ABS/PC), styrene acrylonitrile (SAN), PET/PC, PBT/PC, and/or copolymers or mixtures thereof. The polymeric material can optionally also contain other constituents, such as, for example, glass fibers and/or hollow glass beads. For example, the polymeric main body is glass fiber reinforced. The coefficient of thermal expansion can be varied and adapted through the selection of the glass fiber content in the main body. The hollow main body preferably has a glass fiber content of 20% to 50%, particularly preferably of 30% to 40%. The glass fiber content in the polymeric main body simultaneously improves the strength and stability and can be partially substituted by glass beads to increase the thermal insulation.

The polymeric materials used are usually gas-permeable such that if this permeability is undesirable, additional measures must be taken. For example, for the gas-tight design, a gas-tight or gas impermeable insulating film or corresponding coatings are arranged on the polymeric material or, in the case of a hollow main body, in particular on its outer leg.

Metallic spacer struts are preferably made of aluminum or stainless steel and, thus, naturally have no gas permeability.

In another preferred embodiment, the main body is, however, gas-permeable toward the insulating glass volume, with permeability achievable, for example, by the introduction of openings into the main body. Particularly in the case of metallic hollow desiccant-filled main bodies, whose walls are not gas-permeable, openings are introduced, where required, in order to achieve the necessary gas permeability. For example, to produce a permeable region in the glazing interior legs of the hollow main body, openings are introduced in a necessary number and size in this region of the glazing interior legs. The total number of openings depends on the size of the modular system. The openings connect the hollow chamber of the hollow main body to the insulating glass volume of the modular system, as a result of which a gas exchange becomes possible between them even after insertion of the third pane and separation of the insulating glass volume from the surroundings. The openings are preferably implemented such that the desiccant arranged in the hollow chamber cannot make its way into the inner interpane space. The openings are preferably implemented as slots, particularly preferably as slots with a width of 0.2 mm and a length of 2 mm.

Preferred desiccants are silica gel, CaCl₂), Na₂SO₄, activated carbon, silicates, bentonites, zeolites, and/or mixtures thereof, particularly preferably molecular sieves. This desiccant is preferably introduced into the hollow chamber of the main body.

The modular system has, apart from the double glazing component, the closure component with the third pane element that is insertable into the double glazing component and a closure sealing means for the gas-tight closure of the insulating glass volume by the closure component after arranging the closure component on the receiving opening. The double glazing component, the closure component, and the closure sealing means are component parts of a modular system. By means of the insertion and the gas-tight connection of the closure component into and with the glazing component under the use of the closure sealing means, the gas-tight multiple insulating glazing unit is obtained. When the modular system has the double glazing component, the closure component, and the closure sealing means in the assembled connected state, the multiple insulating glazing unit is formed in the finished state. In contrast thereto, the modular system has the double glazing component, the closure component, and the closure sealing means in the separated state such that the components can be joined to form the multiple insulating glazing unit. Furthermore, the modular system can comprise two separate components, namely the double glazing component with a closure sealing means arranged thereon and the closure component, wherein the closure sealing means is preferably arranged circumferentially around the receiving opening. As another variant, the modular system can comprise the double glazing component as one component and the closure component with a closure sealing means arranged thereon as another component. It is likewise possible, as an additional variant, to fix the closure sealing means, in sections, on the double glazing component and on the closure component before the component assembly.

Selected as the material for the third pane element, which is preferably transparent, is, for example, a material from the group consisting of colored and uncolored glasses, colored and uncolored, rigid, clear plastics that are provided with a barrier layer against vapor diffusion. Preferably, however, a colored or uncolored glass is selected. Preferably, the colored and uncolored glass is selected from the group consisting of colored and uncolored, non-tempered, partially tempered, and tempered float glass, cast glass, ceramic glass, and glass. Float glass is particularly preferred.

Preferably, the third pane element has slightly smaller dimensions than the first and second pane element such that the situation of a triple glazing is produced. When the third pane element is implemented as a functional glass, there exists, with large dimensions of the first and the second pane element, the possibility that the third pane element is formed from a plurality of adjoining sub-pane elements. Sub-pane elements can, for example, be joined to one another and fixed by means of a holding means which surrounds the sub-pane elements on one of their inner edges in each case.

As already stated, another subgroup of preferred embodiments of the modular system is characterized in that the third pane element is implemented as a so-called “functional glass”. It is likewise conceivable to implement the third pane as an electrically controllable display. The advantages achievable by means of the modular system in the processing of such delicate and expensive inner panes have already been described above.

An outer edge of the third pane element is an edge that faces in the direction of the cover portion or the spacer strut of the double glass component when the third pane element is arranged in the double glass component or is also exposed when the third pane is not arranged in the double glass component. An inner edge of the third pane element is an edge that is arranged adjacent an edge of a sub-pane element and faces in its direction.

Preferably, the third pane element is provided along its outer edges with a further spacer element. Preferably, fixing means are provided between the additional spacer and the outer edges of the third pane element. In a preferred embodiment, the additional spacer element has a desiccant acting in the insulating glass volume. Preferably, the additional spacer element is a so-called “double spacer” with a bilateral desiccant reservoir.

The additional spacer preferably corresponds in its structure and its materials to the spacer of the double glazing component, which is implemented as a hollow main body, as described above. In contrast to the above-described spacer in the form of a hollow main body, the additional spacer is part of the closure component and not of the double glass component. Statements concerning the design and structure of the spacer of the double glazing component are transferable to the additional spacer of the closure component, and statements concerning the design and structure of the additional spacer are transferable to the spacer of the double glazing component since their configurations and their structure can be identical.

The additional spacer element preferably has at least one hollow main body, which comprises a first pane contact leg and a second pane contact leg running parallel thereto, a first glazing interior leg, a second glazing interior leg, and an outer leg. A first hollow chamber and a second hollow chamber as well as a groove are introduced into the hollow main body. The first and second hollow chamber form the desiccant reservoirs. The groove runs parallel to the first pane contact leg and the second pane contact leg. The third pane element is arranged and fixed in the groove. The first hollow chamber is adjacent the first glazing interior leg, whereas the second hollow chamber is adjacent the second glazing interior leg, with the glazing interior legs situated above the hollow chambers and the outer leg situated below the hollow chambers. In this context, “above” is defined as facing the insulating glass volume; and “below”, as facing away from the insulating glass volume. Since the groove runs between the first glazing interior leg and the second glazing interior leg, it delimits this laterally and separates the first hollow chamber and the second hollow chamber from one another. Groove side legs of the groove are formed here by the walls of the first hollow chamber or the second hollow chamber. The groove forms a depression that is formed by the two groove side legs and a bottom surface of the groove, wherein the bottom surface is formed by the outer leg.

The glazing interior legs are defined as the legs of the spacer in the form of a hollow main body or an additional spacer, that point, after production of the double glazing component or of the multiple insulating glazing unit, in the direction of the insulating glass volume. The first glazing interior leg is positioned, in the case of the multiple insulating glazing unit, between between the first and the third pane element, whereas the second glazing interior leg is arranged between the third and the second pane element.

The outer leg of the spacer in the form of a hollow main body or additional spacer is the side of the spacer or additional spacer opposite the glazing interior legs, which points away from the insulating glass volume and, optionally, toward an outer insulating film. The outer leg preferably runs perpendicular to the pane contact legs. However, the sections of the outer leg nearest the pane contact legs can, alternatively, be inclined at an angle of preferably 30° to 60° relative to the outer leg running perpendicular to the pane contact legs in the direction of the pane contact legs. This angled geometry improves the stability of the polymeric main body and enables better adhesive bonding of the spacer according to the invention to an insulating film that is optionally applied on the outer leg of the spacer. A planar outer leg that extends perpendicular over its entire course to the pane contact legs has, on the other hand, the advantage that the sealing surface between the spacer and the pane contact legs is maximized and a simpler shape facilitates the production process.

The spacer and/or the additional spacer can include a plurality of grooves that can receive additional pane elements. Alternatively, the pane elements can also be implemented as a composite glass pane.

The spacer in the form of a hollow main body and/or the additional spacer preferably has, along the glazing interior leg, a total width of 10 mm to 50 mm, particularly preferably of 20 mm to 36 mm. The distance between a first and a third pane element or between a third and a second pane element is determined by the selection of the width of the glazing interior leg. Preferably, the widths of the first glazing interior leg and of the second glazing interior leg are equal. Alternatively, asymmetric spacers are also possible, in which the two glazing interior legs have different widths. The precise dimension of the glazing interior leg is governed by the dimensions of the modular system and the desired size of the interpane space.

The spacer in the form of a hollow main body and/or the additional spacer preferably has, along the pane contact leg, a height of 5 mm to 15 mm, particularly preferably of 5 mm to 10 mm. The groove preferably has a depth of 1 mm to 15 mm, particularly preferably of 2 mm to 4 mm.

The wall thickness of the spacer in the form of the hollow main body and/or the additional spacer is preferably 0.5 mm to 15.0 mm, more preferably 0.5 mm to 10.0 mm, particularly preferably 0.7 mm to 1.0 mm.

The spacer and/or the additional spacer preferably includes an insulating film on the outer leg of the main body that is also referred to as an outer insulating film when there is a polymeric main body. The insulating film includes at least one polymeric layer as well as a metallic layer or a ceramic layer. The layer thickness of the polymeric layer is between 5 μm and 80 μm, whereas metallic thin layers and/or ceramic thin layers with thicknesses from 10 nm to 200 nm are used. Within the layer thicknesses mentioned, particularly good leakproofness of the insulating film is achieved.

The insulating film particularly preferably includes at least two metallic layers and/or ceramic layers that are arranged alternatingly with at least one polymeric layer. Preferably, the outer layers are formed by the polymeric layer. The alternating layers of the insulating film can be bonded to one another or applied on one another using a wide variety of methods known from the prior art. Methods for deposition of metallic or ceramic layers are well known to the person skilled in the art. The use of an insulating film with an alternating layer sequence is particularly advantageous in terms of the leakproofness of the system. A defect in one of the layers does not result in a functional loss of the insulating film. By comparison, in the case of a single layer, even a small defect can result in a complete failure. Furthermore, the application of multiple thin layers is advantageous in comparison with one thick layer since the risk of internal adhesion problems rises with increasing layer thickness. Also, thicker layers have higher thermal conductivity making such a film less suitable thermodynamically.

The polymeric layer preferably includes polyethylene terephthalate, ethylene vinyl alcohol, polyvinylidene chloride, polyamides, polyethylene, polypropylene, silicones, acrylonitriles, polyacrylates, polymethyl acrylates, and/or copolymers or mixtures thereof. The metallic layer preferably contains iron, aluminum, silver, copper, gold, chromium, and/or alloys or mixtures thereof. The ceramic layer preferably contains silicon oxides and/or silicon nitrides.

The outer insulating film preferably has gas permeation less than 0.001 g/(m² h).

The composite of the polymeric main body and the outer insulating film preferably has a PSI value less than or equal to 0.05 W/mK, particularly preferably less than or equal to 0.035 W/mK. The insulating film can be applied on the polymeric main body, for example, glued.

The closure component preferably has a cover element that is implemented to interact with the closure sealing means for the gas-tight closure of the insulating glass volume. The cover element is preferably selected from colored and uncolored glasses, colored and uncolored, rigid, clear plastic that are provided with a barrier layer against vapor diffusion. Preferably, however, colored and uncolored glasses are selected. Preferably, the colored and uncolored glass is selected from the group consisting of colored and uncolored, non-tempered, partially tempered, and tempered float glass, cast glass, ceramic glass, and glass. Float glass is particularly preferred. The cover element is preferably made of glass.

The closure sealing means can be inserted, for example, as a butyl strip into a groove of the cover element and/or into a groove along the first and the second sealing sections and the holder strut and/or the spacer struts such that the butyl strip acts against the glass of the first and of the second pane element.

In a preferred embodiment, the cover element is dimensioned such that it can fit sealingly between the first pane element and the second pane element or such that it comes to rest after the insertion of the third pane element into the insulating glass volume on an outer edge of the first pane element and on an outer edge of the second pane element. After incorporation of the closure component in the double glass component, the cover element is preferably flush with the first pane element and the second pane element. When the cover element is dimensioned such that it can fit sealingly between the first pane element and the second pane element, it is arranged between the first and the second pane sealing surface and is preferably positioned on two spacer struts and/or preferably on the holder strut with the use of the closure sealing means. When the cover element, after the insertion of the third pane element into the insulating glass volume, comes to rest on an outer edge of the first pane element and on an outer edge of the second pane element, the closure sealing means is preferably arranged between the outer edges of the pane elements and the cover element.

As already mentioned multiple times, the third pane element is preferably implemented as an electrically controllable pane element, and the cover element has electrical connectors leading from the insulating glass volume to the outside. It is necessary for the electrical connectors in the cover element routed to the outside to pass through the cover element in a moisture-tight manner. The production of such a moisture-tight passage that must continue to exist during the entire service life of the modular system can require special process steps. These can be carried out on the third pane element separately and can subsequently be tested for their quality without a structural combination with the double glazing component having already occurred.

Preferably, the cover element can be nondestructively detachably fastened in its position sealing the insulating glass volume. The third pane element can then be exchanged out of the finished multiple insulating glazing unit if need be or repaired. Advantageously, the modular system is characterized by mechanically operating clamping means that are implemented to press the cover element nondestructively detachably with a retaining force in a gas-tight manner into the double glazing component during arrangement of the closure component on the double glazing component.

The invention further relates to a multiple insulating glazing unit, comprising the modular system, wherein the closure component is arranged on the receiving opening such that the third pane element is inserted into the insulating glass volume of the double glazing component and the closure sealing means is arranged between the closure component and the double glazing component circumferentially around the receiving opening such that it seals the insulating glass volume in a gas-tight manner.

The invention further relates to a method for producing the multiple insulating glazing unit, comprising the steps
Providing the modular system,
Inserting the third pane element into the insulating glass volume of the double glazing component and arranging the closure component and the closure sealing means on the receiving opening such that the closure component with the closure sealing means closes the insulating glass volume in a gas-tight manner.

In the following, the invention is explained in detail with reference to drawings. The drawings are purely schematic presentations and are, consequently, not true to scale. Since they depict only a few of a large number of possibilities as to how the text of the main claim can be realized, they in no way restrict the invention. The drawings depict in:

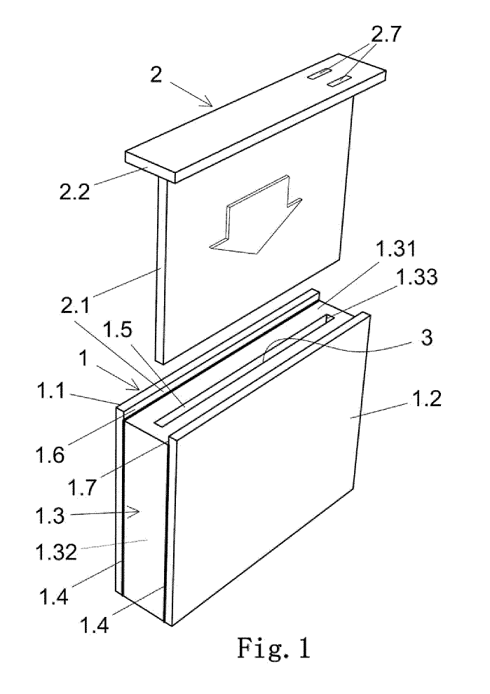

FIG. 1 a possible first embodiment of the modular system according to the invention;

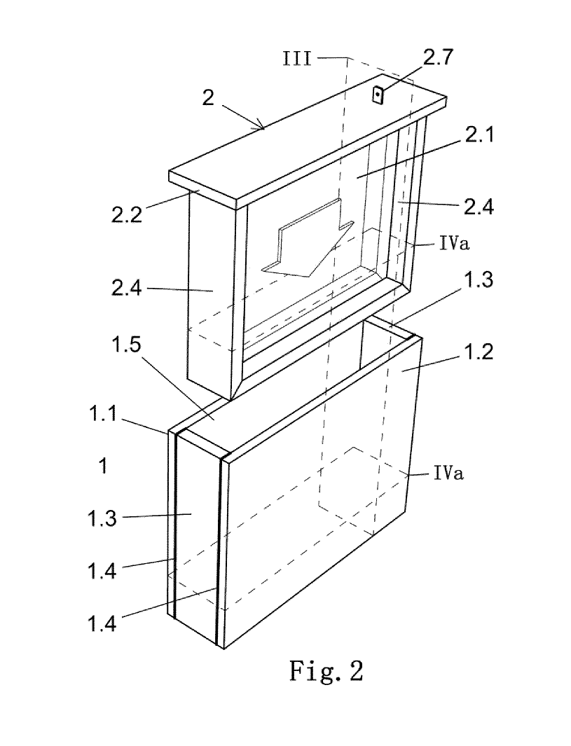

FIG. 2 another possible embodiment of the modular system according to the invention;

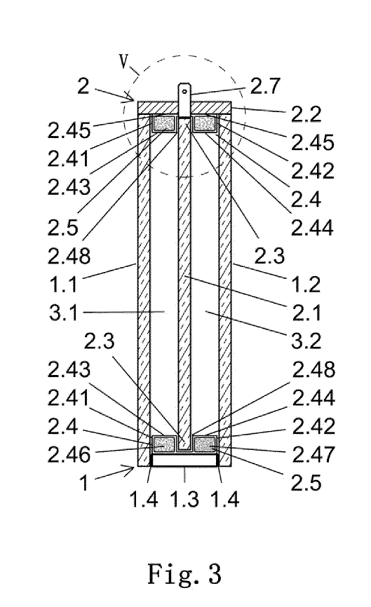

FIG. 3 a cross-section of the modular system according to the invention depicted in FIG. 2 in the assembled state, along the section plane III drawn dashed in FIG. 2;

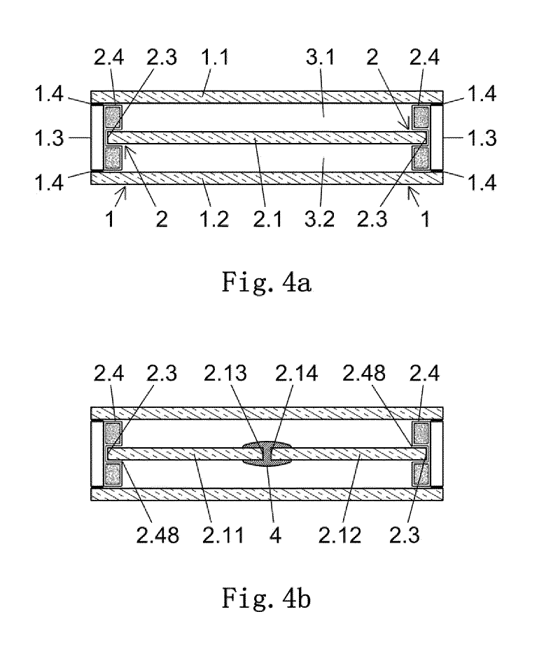

FIG. 4a another cross-section of the modular system according to the invention depicted in FIG. 2 in the assembled state, along the section plane IVa drawn dashed on the double glazing component 1 and on the closure component 2;

FIG. 4b a cross-section of a modular system according to the invention in another possible embodiment;

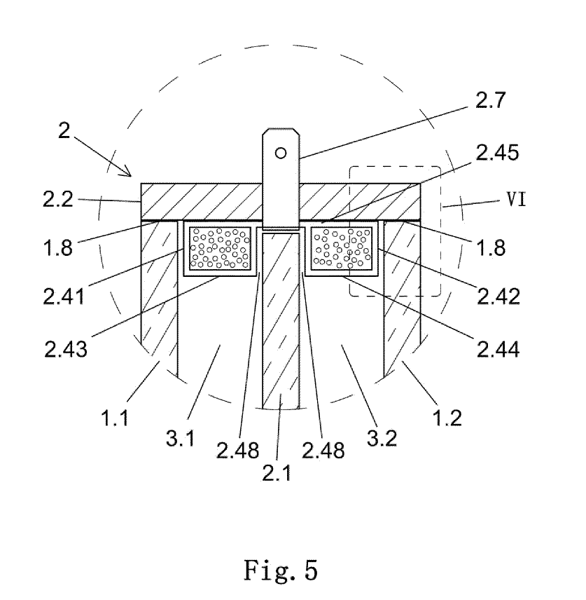

FIG. 5 an enlarged partial view of the modular system depicted in FIG. 3;

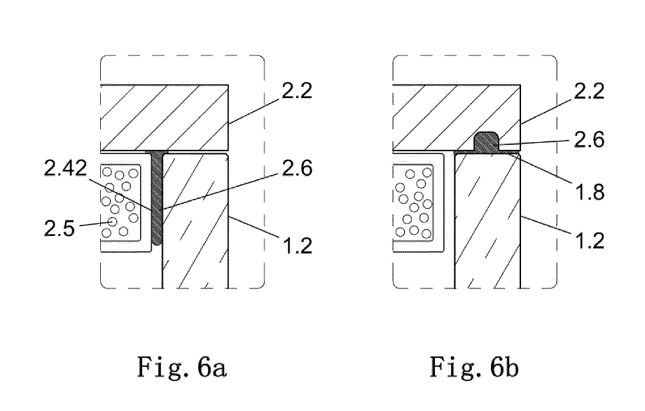

FIG. 6a an enlarged partial view of the region of the modular system identified as VI in FIG. 5 in a possible embodiment; and

FIG. 6b an enlarged partial view of the region of the modular system identified as VI in FIG. 5 in another possible embodiment.

FIG. 1 depicts a possible first embodiment of the modular system according to the invention for a multiple insulating glazing unit. The modular system depicted here has two components, namely a double glazing component 1 and a closure component 2 with closure sealing means (not shown), which can be arranged, for producing a triple insulating glazing unit, in the double glazing component 1 by sliding as indicated by the arrow. The double glazing component 1 comprises a first pane element 1.1 with a first pane sealing surface, a second pane element 1.2 with a second pane sealing surface, and a spacer arranged between the first pane sealing surface and the second pane sealing surface. The spacer is composed of a plurality of spacer struts 1.3, which enclose an insulating glass volume between the first pane element 1.1 and the second pane element 1.2 and are fixed in a gas-tight manner by means of fixing means 1.4 to the first pane sealing surface and to the second pane sealing surface. The plurality of spacer struts 1.3 are implemented as a partially open frame and arranged such that a receiving opening 1.5 is implemented between two spacer struts 1.3, which opening is dimensioned such that a third pane element 2.1 fastened on the closure component 2 can be inserted through it into the insulating glass volume 3 of the double glazing component 1.

One of the spacer struts 1.3 is implemented as a holder strut 1.31 and has a receiving opening 1.5 that is dimensioned such that the third pane element 2.1 can be inserted through it into the insulating glass volume. The holder strut 1.31 surrounds the receiving opening 1.5 on all sides. Adjacently connecting to the holder strut 1.31, a first sealing section 1.6 on the first pane element 1.1 is exposed, and a second sealing section 1.7 on the second pane element 1.2 is exposed.

The third pane element 2.1 is part of the closure component 2 that is further provided, in addition to the third pane element 2.1 that can be inserted into the double glazing component 1, a closure sealing means (not shown) for the gas-tight closing of the insulating glass volume after arrangement of the closure component 2 on the receiving opening 1.5. The closure component 2 also has a cover element 2.2, which interacts with the closure sealing means for the gas-tight closure of the insulating glass volume 3. The cover element 2.2 is dimensioned such that it can fit sealingly between the first pane element 1.1 and the second pane element 1.2. The third pane element 2.1 is implemented as an electrically controllable pane element. The cover element 2.2 has, purely by way of example, two electrical connectors 2.7 leading from the insulating glass volume to the outside.

The spacer struts 1.3 are implemented as hollow main bodies. The hollow main body has two parallel pane contact legs (not shown), an outer leg 1.32, and two glazing interior legs 1.33, of which one is discernible. A desiccant is at least partially arranged (not shown) in the hollow main body. The hollow main body extends between the first pane element 1.1 and the second pane element 1.2. Whereas the first pane contact leg (not shown) is fixed on the first pane sealing surface of the first pane elements 1.1, the second pane contact leg (not shown) is fixed on the second pane sealing surface of the second pane element 1.2.

FIG. 2 depicts another possible embodiment of the modular system according to the invention. The modular system depicted in FIG. 2 corresponds to the modular system depicted in FIG. 1 with the differences that the spacer has no holder strut 1.31. The spacer struts 1.3 are arranged U-shaped along the pane edges of the outer pane 1.1,1.2. Upwardly, the spacer strut is completely lacking such that the receiving opening 1.5 is formed between the two vertically extending spacer struts 1.3. Also, the third pane element 2.1 of the closure component 2 is surrounded along its outer edges with a further spacer element 2.4. This additional spacer element 2.4 is implemented as a so-called “double spacer”. It has two parallel hollow chambers to accommodate desiccant, which are separated from one another by a groove. The additional spacer element can be positioned on the outer edges of the third pane element 2.1 with this groove. The outer edges of the third pane element 2.1 are protected thereby when the cover element 2.2 is joined with the double glazing component 1.

FIG. 3 depicts a cross-section of the second embodiment of the modular system depicted in FIG. 2 in the assembled state, i.e., the closure component 2 has been slid into the double glazing component 1 in the direction of the arro yeah w and arranged therein such that a multiple insulating glazing unit is formed. The cross-sectional plane is identified in FIG. 2 with III. Consequently, FIG. 3 depicts a triple insulating glazing unit after completion. The spacer strut 1.3 is arranged between the first pane element 1.1 and the second pane element 1.2 and is fixed by fixing means 1.4 to the first pane sealing surface and to the second pane sealing surface in a gas-tight manner. The closure component 2 is inserted into the double glazing component 1 such that an insulating glass volume 3.1 is formed between the first pane element 1.1 and the third pane element 2.1 and another insulating glass volume 3.2 is formed between the second pane element 1.2 and the third pane element 2.1, which insulating glass volumes are separated from one another by the third pane element 2.1 plus the additional spacer 2.4, which is arranged along the outer edges 2.3 of the third pane element 2.1.

The additional spacer 2.4 is implemented as a hollow and preferably polymeric main body in the form of a so-called “double spacer”, which can be glass fiber reinforced. The additional spacer 2.4 comprises a first pane contact leg 2.41, a second pane contact leg 2.42 running parallel thereto, a first glazing interior leg 2.43, a second glazing interior leg 2.44, and an outer leg 2.45. Situated between the outer leg 2.45 and the first glazing interior leg 2.43 is a first hollow chamber 2.46, whereas a second hollow chamber 2.47 is arranged between the outer leg 2.45 and the second glazing interior leg 2.44. Situated between the two hollow chambers 2.46, 2.47 is a groove 2.48, which runs parallel to the pane contact legs 2.41, 2.42. Two groove side legs (not shown) of the groove 2.48 are formed by the walls of the two hollow chambers 2.46, 2.47, whereas a bottom surface (not shown) of the groove 2.48 is directly adjacent the outer leg 2.45. The outer leg 2.45 runs, for the most part, perpendicular to the pane contact legs 2,41, 2.42 and parallel to the glazing interior legs 2.43, 2.44. The glazing interior legs 2.43, 2.44 have openings (not shown) at regular intervals, which, in each case, connect one of the hollow chambers 2.46, 2.47 to the respective insulating glass volume 3.1, 3.2. The first hollow space 2.46 and the second hollow space 2.47 are, at least in sections, filled with a desiccant 2.5 that can absorb humidity from the insulating glass volumes 3.1, 3.2.

The first pane contact leg 2.41 is fixed on the first pane element 1.1, and the second pane contact leg 1.2 is fixed on the second pane element 1.2. The glazing interior legs 2.43 or 2.44 are adjacent the insulating glass volumes 3.1 or 3.2, respectively. The first glazing interior leg 2.43 is positioned between the first pane element 1.1 and the third pane element 2.1, whereas the second glazing interior leg 2.44 is arranged between the third pane element 2.1 and the second pane element 1.2. The outer leg 2.45 is the side of the additional spacer 2.4 opposite the glazing interior legs 2.43, 2.44, which face away from the insulating glass volumes 3.1, 3.2. The outer leg 2.45 is arranged either adjacent the spacer struts 1.3 or the cover part 2.2. The groove 2.48 encloses the outer edges 2.3 of the third pane element 2.1.

The closure component 2 has the electrical connector 2.7, which is arranged through the cover part 2.2 in a gas-tight manner such that the electrical connector 2.7 electrically contacts the third pane element 2.1 implemented as a functional glass pane.

FIG. 4a depicts another cross-section of the modular system according to the invention depicted in FIG. 2 in the assembled state, i.e., the closure component 2 is slid into the double glazing component 1 in the direction of the arrow and arranged therein such that a multiple insulating glazing unit is formed. The cross-sectional plane is identified with IVa. Consequently, FIG. 4a depicts a triple insulating glazing unit after completion. Two spacer struts 1.3 are arranged between the first pane element 1.1 and the second pane element 1.2 and fixed by fixing means 1.4 to the first pane sealing surface and to the second pane sealing surface in a gas-tight manner. The two spacer struts 1.3 are arranged between opposing edges of the two pane elements 1.1, 1.2. The insulating glass volume 3.1 is formed between the first pane element 1.1 and the third pane element 2.1, and the other insulating glass volume 3.2 is formed between the second pane element 1.2 and the third pane element 2.1 such that the insulating glass volumes are separated from one another by the third pane element 2.1 plus the additional spacer 2.4, which is arranged along the outer edges 2.3 of the third pane element 2.1.

FIG. 4b depicts a cross-section of a modular system according to the invention in another possible embodiment. The modular system is assembled to form a multiple insulating glazing unit. FIG. 4b depicts a view of a variant of the modular system depicted in FIG. 4a in cross-section. The embodiment depicted in FIG. 4b corresponds to the embodiment depicted in FIG. 4a with the difference that the third pane element has at least two sub-pane elements 2.11, 2.12, that are connected and fixed to one another by at least one holder 4. The holder 4 is implemented such that it encloses the first sub-pane element 2.11 on its inner edge 2.13 and the second sub-pane element 2.12 on its inner edge 2.14, whereas the outer edges 2.3 of the sub-pane elements 2.11, 2.12 are arranged in the groove 2.48 of the spacer 2.4.

FIG. 5 depicts an enlarged partial view of the modular system depicted in FIG. 3 in the region of the closure component 2. The modular system is assembled to form the multiple insulating glazing unit. The first pane contact leg 2.41 is arranged on the first pane element 1.1, and the second pane contact leg 2.42 is arranged on the second pane element 1.2. The first glazing interior leg 2.43 is adjacent the first insulating glass volume 3.1, and the second glazing interior leg 2.44 is adjacent the second insulating glass volume 3.2. The outer leg 2.45 is arranged adjacent the cover part 2.2. The third pane element 2.1 is arranged in the groove 2.48. The cover element 2.2 rests on an outer edge 1.8 of the first pane element 1.1 and on an outer edge 1.8 of the second pane element 1.2.

FIG. 6a depicts another enlarged partial view of the modular system depicted in FIG. 5 in a possible embodiment. A closure sealing means 2.6 in the form of a butyl rubber layer is arranged between the second pane element 1.2 and the second pane contact leg 2.42. Before the joining of the double glazing component 1 and the closure component 2, the closure sealing means 2.6 can be fixed either on the double glazing component 1 or on the closure component 2. It is likewise conceivable for it to be arranged in sections on the double glazing component 1 and in sections on the closure component 2, provided the required gas tightness is ensured in the assembled state.

FIG. 6b depicts an enlarged partial view of the modular system depicted in FIG. 5 in another possible embodiment. As an alternative or in addition to the embodiment depicted in FIG. 6a, the modular system can have a sealingly arranged closure sealing means 2.6, for example, in the form of a butyl rubber cord arranged in a groove, between the outer edge 1.8 of the second pane element 1.2 and the cover part 2.2. With regard to the structural arrangement of the closure sealing means 2.6 before assembly, the statements made concerning FIG. 6a apply accordingly.

### LIST OF REFERENCE CHARACTERS

1 double glazing component
1.1 first pane element
1.2 second pane element
1.3 spacer strut
1.31 holder strut
1.32 outer leg
1.33 glazing interior leg
1.4 fixing means
1.5 receiving opening
1.6 first sealing section
1.7 second sealing section
1.8 outer edge
2 closure component
2.1 third pane element
2.11 sub-pane element
2.12 sub-pane element
2.13 first inner edge
2.14 second inner edge
2.2 cover element
2.3 outer edges
2.4 spacer element
2.41 first pane contact leg
2.42 second pane contact leg
3.43 first glazing interior leg
2.44 second glazing interior leg
2.45 outer leg
2.46 first hollow chamber
2.47 second hollow chamber
2.48 groove
2.5 desiccant
2.6 closure sealing means
2.7 electrical connector
3 insulating glass volume
3.1 first insulating glass volume
3.2 second insulating glass volume
4 holder

1. A modular system for a multiple insulating glazing unit comprising
a double glazing component including
a first pane element with a first pane sealing surface,
a second pane element with a second pane sealing surface,
a spacer that is arranged between the first pane sealing surface and the second pane sealing surface and that is composed of at least one spacer strut that encloses an insulating glass volume between the first pane element and the second pane element and is fixed in a gas-tight manner by a fixing system to the first pane sealing surface and to the second pane sealing surface, wherein the at least one spacer strut is implemented and arranged as a frame open in sections such that a receiving opening is implemented between two spacer struts, which receiving opening is dimensioned such that a third pane element can be inserted through said opening into the insulating glass volume of the double glazing component,
a closure component with the third pane element,
and
a closure sealing system for the gas-tight closure of the insulating glass volume by the closure component after arranging the closure component on the receiving opening.

2. The modular system according to claim 1, wherein at least one of the spacer struts is implemented as a holder strut and has the receiving opening.

3. The modular system according to claim 2, wherein the holder strut surrounds the receiving opening on all sides.

4. The modular system according to claim 2, wherein adjacently connecting to the holder strut or to the receiving opening, a first sealing section on the first pane element and a second sealing section on the second pane element are exposed.

5. The modular system according to claim 4, wherein the first sealing section is arranged on the first pane sealing surface and the second sealing section is arranged on the second pane sealing surface.

6. The modular system according to claim 1, one of the preceding claim, wherein the spacer struts are implemented moisture-tight against moisture penetrating from the outside but desiccant-free.

7. The modular system according to claim 1, wherein the third pane element is provided along its outer edges with a further spacer element.

8. The modular system according to claim 7, wherein the further spacer element has a desiccant acting in the insulating glass volume.

9. The modular system according to claim 1, wherein the closure component has a cover element that is implemented to interact with the closure sealing system means for the gas-tight closure of the insulating glass volume.

10. The modular system according to claim 9, wherein the cover element is dimensioned such that the cover element can fit sealingly between the first pane element and the second pane element or that after the insertion of the third pane element into the insulating glass volume, it the cover element comes to rest on an outer edge of the first pane element and on an outer edge of the second pane element.

11. The modular system according to claim 9, wherein the third pane element is implemented as an electrically controllable pane element and the cover element has electrical connectors leading from the insulating glass volume to the outside.

12. The modular system according to claim 9, wherein the cover element can be nondestructively detachably attached in its position sealing the insulating glass volume.

13. The modular system according to claim 12, comprising a mechanically operating clamp arranged to press the cover element nondestructively detachably with a retaining force in a gas-tight manner into the double glazing component during arrangement of the closure component on the double glazing component.

14. A multiple insulating glazing unit, comprising:
a modular system according to claim 1, wherein the closure component is arranged on the receiving opening such that the third pane element is inserted into the insulating glass volume of the double glazing component and the closure sealing system is arranged between the closure component and the double glazing component circumferentially around the receiving opening such that closure sealing system closes the insulating glass volume in a gas-tight manner.

15. Method A method for producing a multiple insulating glazing unit, comprising:
providing a modular system according to claim 1,
inserting the third pane element into the insulating glass volume of the double glazing component and arranging the closure component and the closure sealing system means on the receiving opening such that the closure component with the closure sealing system closes the insulating glass volume in a gas-tight manner.
